(19) United States
(12) Patent Application Publication
(10) Pub. No.: US 2019/0220768 A1
(43) Pub. Date: Jul. 18, 2019

(54) CONSTRUCTING TOPOLOGY FOR SATISFYING PARTITION TOLERANCE IN CONSORTIUM BLOCKCHAIN CONSENSUS

(71) Applicants: PEKING UNIVERSITY SHENZHEN GRADUATE SCHOOL, Shenzhen (CN); CHINA NATIONAL DIGITAL SWITCHING SYSTEM ENGINEERING & TECHNOLOGICAL R&D CENTER, Zhengzhou (CN); SHENZHEN CESTBON TECHNOLOGY CO. LIMITED, Guangdong (CN)

(72) Inventors: Hui Li, Shenzhen (CN); Jiangxing Wu, Shenzhen (CN); Kejiao Li, Shenzhen (CN); Peng Yi, Shenzhen (CN); Han Wang, Shenzhen (CN); Fusheng Zhu, Shenzhen (CN); Hanxu Hou, Shenzhen (CN); Kedan Li, Shenzhen (CN); Xichun Zhang, Shenzhen (CN)

(73) Assignees: PEKING UNIVERSITY SHENZHEN GRADUATE SCHOOL, Shenzhen (CN); CHINA NATIONAL DIGITAL SWITCHING SYSTEM ENGINEERING & TECHNOLOGICAL R&D CENTER, Zhengzhou (CN); SHENZHEN CESTBON TECHNOLOGY CO. LIMITED, Guangdong (CN)

(21) Appl. No.: 16/361,067

(22) Filed: Mar. 21, 2019

Related U.S. Application Data
(63) Continuation-in-part of application No. 15/997,710, filed on Jun. 5, 2018.
Application No. 15/997,710 is a continuation of application No. PCT/CN2017/084431, filed on May 16, 2017.
Application No. PCT/CN2017/084431 is a continuation of application No. PCT/CN2018/090453, filed on Jun. 8, 2018.

(51) Int. Cl. G06N 7/08; G06N 7/00

(52) U.S. Cl. CPC G06N 7/08; G06N 7/005

(57) ABSTRACT

An example topology construction method for satisfying partition tolerance, comprising: combining the consortium blockchain consensus mechanism with the network topology structure to make the consortium blockchain consensus satisfy the partition tolerance in probability; abstracting the partition tolerance of a system into a class of convergent Markov process and computing a steady-state probability of the system; estimating the probability and the average minimum repair time of failing to meet consistency or availability in the event of a partition failure with a given number of failure channels, and a partition tolerance probability and an average minimum repair time of the system are obtained; and analyzing the resource overhead and the partition tolerance under different network topologies according to the obtained partition tolerance probability and the average minimum repair time, and constructing the network topology structure with suitable scale and high partition tolerance for the consortium blockchain consensus of different needs.

### RELATED APPLICATIONS

This application is a continuation of PCT Patent Application PCT/CN/2018/090453, filed Jun. 8, 2018. This application is also a continuation-in-part of U.S. patent application Ser. No. 15/997,710, filed Jun. 5, 2018, now allowed, which is a continuation of PCT/CN2017/084431 filed May 16, 2017. All above-identified patent applications are hereby incorporated by reference in their entireties.

### TECHNICAL FIELD

The present disclosure generally relates to network construction technologies and particularly relates to topology constructions that satisfy the partition tolerance in the consortium blockchain consensus.

### BACKGROUND

Blockchain refers to a pattern of constructing the chained-block data structure that is unforgeable, non-tamperable and traceable through transparent and trusted rules in a Peer-to-Peer network environment to implement and manage transaction processing. In some senses, a blockchain is a chained data structure in which data blocks are sequentially connected in a chronological order, and is an distributed ledger that cannot be tempered or falsified by cryptography; in a broader sense, the blockchain is a new, distributed infrastructure and computing method that uses the chained-block data structure to validate and store data, uses distributed consensus algorithms to generate and update data, uses cryptography to ensure the security of data transmission and access, and utilizes smart contracts consisting of automated script code to program and manipulate data.

### SUMMARY

In some implementations, a topology construction method for satisfying partition tolerance under consortium blockchain consensus, wherein the topology construction method includes the following steps: S1. Combining the consortium blockchain consensus mechanism with the network topology structure to make the consortium blockchain consensus satisfy the partition tolerance in probability; S2. Abstracting the partition tolerance of the system into a class of convergent Markov process and obtaining the steady-state probability of the system; S3. Estimating the probability and the minimum repair time of failing to meet consistency or availability in the event of a partition failure with a given number of failure channels, and the partition tolerance probability and the average minimum repair time of the system are obtained; and S4. Analyzing the resource overhead and the partition tolerance under different network topologies according to the obtained partition tolerance probability and the average minimum repair time, and constructing a network topology structure with suitable scale and high partition tolerance for the consortium blockchain consensus of different needs.

In some implementations, the Markov process in the step S2 converges to a steady-state distribution independent of the initial distribution, and in the single network topology structure, computing the steady-state probability of the system includes the following steps: S21. Multiplying the state transition matrix P iteratively by itself; and S22. Determining whether the 2-norm of the difference between two consecutive products is less than a set convergence precision; wherein if less than, determining that the power value of P at this time is the steady-state probability matrix P* and if not less than, returning to the step S21.

In some implementations, the MTBF and MTTR of each analysis element in the step S3 are independent processes without memory, and each mean value is constant; and in the single network topology structure, computing the partition tolerance probability of the system includes the following steps: S311. Sampling N times for each possible state of the steady-state system; S312. Estimating the probability of failing to meet consistency or availability in the event of a partition failure in each state; and S313. Calculating the partition tolerance probability of the system according to a full probability formula, wherein the full probability formula is: p=1−Σᵢ₌₁^{l}P{steady-state i}P{failing to meet consistency or availability in the event of a partition failure |steady-state i}, 1 indicates the total number of channels, and i indicates that only i channels are in a failure state in the steady state system.

In some implementations, in the single network topology structure, computing the average minimum repair time of the system includes the following steps: S321. Calculating the minimum repair time for each sample of failing to meet consistency or availability in the event of a partition failure; and S322. Multiplying the weight of the sample in the whole system partition tolerance problem, and obtaining the average minimum repair time of the system.

In some implementations, in the hierarchical network topology, according to the process of consensus, the partition tolerance of a lower-level domain is not only affected by its network topology but is also related to the partition tolerance of the higher-level domains; wherein the partition tolerance probability of the system is p=1−Σₘ₌₁ⁿ Σ(i₁,i₂,i₃, . . . ,iₘ) pᵢ₁pᵢ₁ᵢ₂pᵢ₁ᵢ₂ᵢ₃ . . . p_{i1i2i3 . . . im-1}(1−p_{i1i2i3 . . . im}); wherein the average minimum repair time of the system is

$$t = {\sum }_{m = 1}^{n} \sum ( {i}_{1} , {i}_{2} , {i}_{3} , … , {i}_{m} ) {t}_{i 1 i 2 i 3 … i m} \cdot \frac{pi 1 pi 1 i 2 pi 1 i 2 i 3 … pi 1 i 2 i 3 … i m - 1 ( 1 - Pi 1 i 2 i 3 … i m )}{1 - p} ;$$

where p_{i1i2i3 . . .} represents the partition tolerance probability of each domain, and t _{i1i2i3 . . .} represents the average minimum repair time of each domain.

In some implementations, a topology construction system for satisfying the partition tolerance in the consortium blockchain consensus, wherein the topology construction system includes: a combination module configured to combine a consortium blockchain consensus mechanism and a network topology structure to make the consortium blockchain consensus probabilistically satisfy partition tolerance; a convergence module configured to abstract the partition tolerance of the system into a class of convergent Markov process and obtain the steady-state probability of the system; a sampling estimation module configured to estimate the probability and the minimum repair time of failing to meet consistency or availability in the event of a partition failure with a given number of failure channels, and to obtain the partition tolerance probability and the average minimum repair time of the system; and a network construction module configured to analyze the resource overhead and the partition tolerance under different network topologies according to the partition tolerance probability and the average minimum repair time, and to construct the network topology with suitable size and higher partition tolerance for the consortium blockchain consensus of different needs.

In some implementations, the Markov process in the convergence module converges to a steady-state distribution independent of the initial distribution, and wherein in the single network topology, computing the steady-state probability of the system includes: a loop multiplication unit configured to multiply the state transition matrix P iteratively by itself; and a determining unit configured to determine whether the 2-norm of the difference between two consecutive products is smaller than a set convergence precision; wherein if it is less than, the power value of P at this time is determined to be the steady-state probability matrix P*, and if it is not less than, returning to the loop multiplication unit.

In some implementations, the MTBF and MTTR of each analysis element in the sampling estimation module are independent processes without memory, and each mean value is constant; wherein in the single network topology structure, computing the partition tolerance probability of the system includes: a sampling unit configured to sample N times for each possible state of the steady-state system; an estimation unit configured to estimate a probability of failing to meet consistency or availability in the event of a partition failure in each state; and a calculation unit configured to calculate the partition tolerance probability of the system according to a full probability formula, wherein the full probability formula is: p=1−Σᵢ₌₁^{l}P{steady-state i}P{failing to meet consistency or availability in the event of a partition failure |steady-state i}, 1 indicates the total number of channels, and i indicates that only i channels are in a failure state in the steady-state system.

In some implementations, in the single network topology, computing the average minimum repair time of the system includes: a calculating the minimum repair time unit configured to calculate the minimum repair time for each sample that fails to meet consistency or availability in the event of a partition failure; and a calculating the average minimum repair time unit configured to multiply with a weight of the sample in the total system partition tolerance problem, and to obtain the average minimum repair time of the system.

In some implementations, in the hierarchical network topology structure, according to the process of consensus, the partition tolerance of a lower-level domain is not only affected by its network topology structure but is also related to the partition tolerance of the higher-level domains; wherein the partition tolerance probability of the system is p=1−Σₘ₌₁ⁿΣ(i₁,i₂,i₃, . . . ,iₘ) pᵢ₁pᵢ₁ᵢ₂pᵢ₁ᵢ₂ᵢ₃ . . . p_{i1i2i3 . . . im-1}(1−p_{i1i2i3 . . .im}); wherein the average minimum repair time of the system is

$$t = {\sum }_{m = 1}^{n} \sum ( {i}_{1} , {i}_{2} , {i}_{3} , … , {i}_{m} ) {t}_{i 1 i 2 i 3 … i m} \cdot \frac{pi 1 pi 1 i 2 pi 1 i 2 i 3 … pi 1 i 2 i 3 … i m - 1 ( 1 - Pi 1 i 2 i 3 … i m )}{1 - p} ;$$

where p_{i1i2i3 . . .} represents the partition tolerance probability of each domain, and t_{i1i2i3 . . .} represents the average minimum repair time of each domain.

The beneficial effects of the present disclosure are: combining the network topology with the consortium blockchain consensus mechanism, so that the consortium blockchain consensus satisfies the partition tolerance in probability, and thus may achieve the coexistence of the three factors of CAP, and has high practical significance; using the mean time between failures and the mean time to repair that are constant over a period of time as parameters improves the prediction accuracy of the Markov model for the probability distribution trend of the system state; estimating the probability and the minimum repair time of failing to satisfy consistency or availability in the event of a partition failure with a given number of failure channels, so as to fully adapt to the self-partition tolerance and network topology characteristics of the consensus mechanism.

### BRIEF DESCRIPTION OF THE DRAWINGS

FIG. 1 is a schematic diagram of a Markov state transition diagram for a general network topology structure.

FIG. 2 is a schematic diagram of a domain number of a hierarchical network topology structure in accordance with some implementations of the present disclosure.

FIG. 3 is a schematic diagram of a partition tolerance probability of a multi-dimensional hypercube network topology in accordance with some implementations of the present disclosure.

FIG. 4 is a schematic diagram of an average minimum repair time of a multi-dimensional hypercube network topology in accordance with some implementations of the present disclosure.

FIG. 5 is a schematic diagram of a partition tolerance probability of a multi-point fully connected network topology structure in accordance with some implementations of the present disclosure.

FIG. 6 is a schematic diagram of an average minimum repair time of a multi-point fully connected network topology structure in accordance with some implementations of the present disclosure.

FIG. 7 is a schematic diagram of a lower boundary situation of a hierarchical network topology structure in accordance with some implementations of the present disclosure.

FIG. 8 is a schematic diagram of a fully symmetric hierarchical network topology in accordance with some implementations of the present disclosure.

FIG. 9 is a schematic diagram of a semi-symmetric hierarchical network topology in accordance with some implementations of the present disclosure.

FIG. 10 is a schematic diagram of an asymmetric hierarchical network topology in accordance with some implementations of the present disclosure.

FIG. 11 is a schematic diagram of an example 5-d hypercube topology with nodes that are not directly connected in accordance with some implementations of the present disclosure.

FIG. 12 is a flowchart of a topology construction method for satisfying partition tolerance in the consortium blockchain consensus in accordance with some implementations of the present disclosure.

The implementations disclosed herein are illustrated by way of example, and not by way of limitation, in the figures of the accompanying drawings. Like reference numerals refer to corresponding parts throughout the drawings.

### DETAILED DESCRIPTION

The blockchain is essentially a decentralized distributed ledger, and these distributed ideas have been proposed and matured long before the blockchain emerged. In 2000, Eric Brewer made a conjecture at a seminar that consistency(C), availability(A), and partition tolerance(P) could not be fully satisfied in a distributed system at the same time. In 2002, Lynch et al. proved this conjecture and referred to it as the CAP theorem. For the first time, the CAP theorem refines the three factors of consistency, availability, and partition tolerance into important features of distributed system design. Specifically, (1) consistency means that any operation in the system should appear to be “atomic” or serial, all operations appear to be globally ordered; (2) availability means that any normal node after requested should receive response in a limited amount of time; (3) partition tolerance means that when the network is partitioned at a particular time, the system can still meet the consistency and availability.

Due to the complex network environment of the blockchain, mainstream blockchain consensus algorithms such as PoW satisfy high availability and partition tolerance by weakening strict consistency for long-term eventual consistency, but this will result in limited TPS performance of the system. Therefore, some high-performance blockchain systems such as EOS choose to sacrifice partial partition tolerance by controlling the number of nodes participating in bookkeeping in exchange for TPS performance improvement. Both of these methods only choose two factors as the primary reinforcement point among consistency, availability and partition tolerance, and significantly weaken the third factor. There is still much room for the CAP limit.

Bitcoin uses an Internet-based peer-to-peer distributed network architecture with network routing capabilities on each node. When a new node needs to access the Bitcoin network, it should perform the following steps:

1. Using the DNS seed or ‘seednode’ command to find a valid node in the Bitcoin network.

2. Sending a ‘version’ message containing the essential authentication content to the discovered valid bitcoin node for the initial handshake communication process to establish a connection.

3. Sending its IP address to the connected node. After receiving, the connected node forwards the IP address to its respective connected nodes, so that more nodes in the network receive the new node.

4. Asking the connected node for a list of known node IP addresses to find more connectable nodes.

5. Periodically sending messages to the connected nodes to maintain the connection. If there is no communication with a node for more than 90 minutes, it is determined to have been disconnected and starts to find a new node. Since Bitcoin communication is based on the TCP protocol, each node has a limited number of TCP connections, so an excessive number of IP addresses are ignored.

After the startup is complete, the node remembers the nodes that were successfully connected recently, and when it restarts, it can quickly re-establish the connection with the previous nodes. If the previous nodes are unable to connect, re-execute from step (1).

In the process of communication between bitcoin nodes, it is not required to maintain the topology of the network, that is, it is not necessary to abstract the network logically, and the flooding strategy is used for data transmission.

The flooding strategy is simple and easy to implement, and the behaviors such as node joining, leaving, and failure have a less negative impact on the whole system, so the network reliability is high. However, because the mesh structures are connected, flooding may cause the nodes to repeatedly receive the same data multiple times, resulting in redundant reception of node information, and a large amount of useless repeated data transmission also consumes network resources.

The Proof of Authority (PoA) consensus algorithm based on the consortium blockchain was proposed by Ethereum co-founder and former chief technology officer Gavin Wood in 2017 and is currently used in the Ethereum test network Kovan. PoA's consensus process is: first, a set of initially authorized signers are specified in the creative block. After the mining is started, the signer starts to sign the generated block and broadcast it. If other authorized signers object to the block's generation, a “kick out” vote is held on the signer of the block, and if the number of votes exceeds 50% of the total number of signers, the bookkeeping right of the corresponding signer is canceled.

In order to reduce the loss caused by the malicious signers, the same signer can only sign one of the (SIGNER_{—COUNT/}2)+1 blocks. To reduce the probability of forks, the system has a signer in the IN-TURN state at each height, and other signers are in the OUT-OF-TURN state. The signer in the IN-TURN state can immediately broadcast its block. The signer in the OUT-OF-TURN state who generates a block will randomly delay for a while before broadcasting.

The PoA consensus relies on a practical and trustworthy authentication mechanism. Considering that the identity of the signers is open to the whole network, once more than half of the signers are attacked, the system cannot guarantee the correctness of the blocks. On the other hand, compared to the conventional PBFT consensus algorithm, the PoA consensus algorithm achieves high availability and partition tolerance by weakening the consistency requirement as non-consistency (Aura client) or eventual consistency (Clique client).

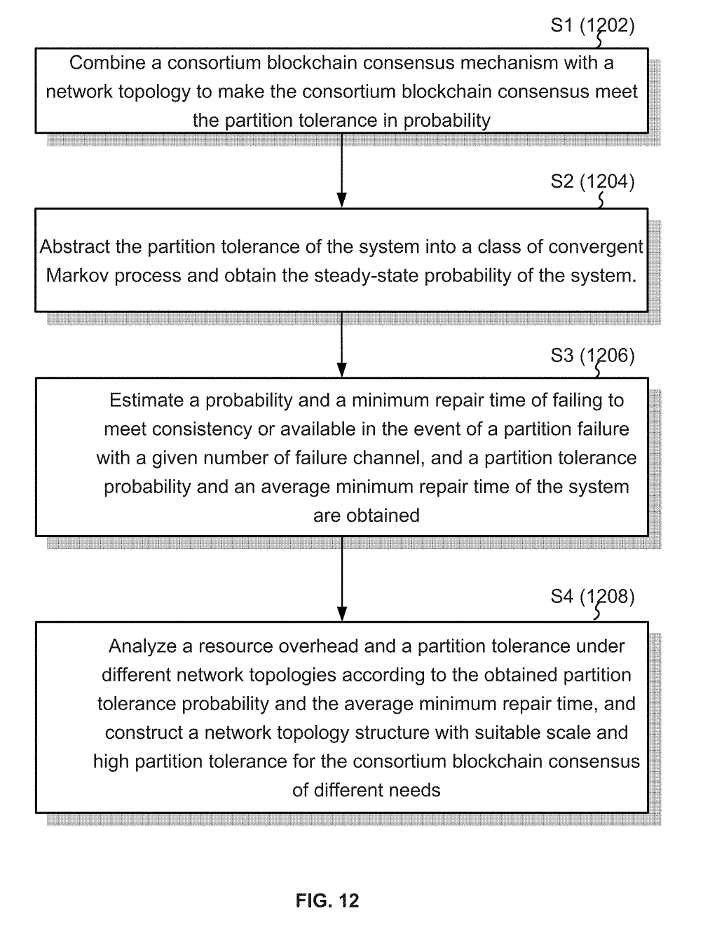

As shown in FIG. 12, the topology construction method for satisfying partition tolerance in the consortium blockchain consensus provided by the present disclosure is as follows:

The existing blockchain systems only strengthen two factors among consistency, availability, and partition tolerance at the consensus level, accompanied by a significant weakening of the third factor, which is still far from the CAP limit.

Also, at the data communication level, the current mainstream blockchain systems do not consider how to maintain the network topology, which brings potential network communication risks and resource waste.

In view of the above problems, the present disclosure—a topology construction method and system that satisfies the partition tolerance in the consortium blockchain consensus, combines the network topology with the consortium blockchain consensus mechanism, so that the consortium blockchain consensus satisfies the partition tolerance in terms of probability, and further may achieve the coexistence of three factors of CAP. The present disclosure also proposes a partition tolerance calculation method, which abstracts the partition tolerance problem of the system into a class of convergent Markov process, and uses simulation software such as MATLAB to sample and calculate the probability and average minimum repair time for the network failing to meet consistency or availability in the event of a partition failure. According to the above calculation method, the present disclosure specifically analyzes resource overhead and partition tolerance in different network topologies and constructs network topology with proper scale and high partition tolerance for the consortium blockchain consensus of different needs.

The technical solution of the present disclosure combines the network topology with the consortium blockchain consensus mechanism on the basis of not affecting the consistency and availability of the consensus algorithm, so that the consortium blockchain consensus may satisfy the partition tolerance in terms of probability, and thus may achieve the coexistence of three factors of CAP which has a highly practical meaning.

A partition tolerance calculation method is proposed to abstract the partition tolerance problem of the system into a class of convergent Markov process. Moreover, by using the mean time between failures and the mean time to repair that remains constant over some time as parameters, the prediction accuracy of the Markov model for the probability distribution trend of the system state is improved.

Different consensus mechanisms have different partition tolerance. The situation of partition failures may also be different under different network topologies, so their failure probability has different characteristics. By using the simulation software such as MATLAB to estimate the probability and the minimum repair time of failing to satisfy consistency or availability in the event of a partition failure with a given number of failure channels, the self-partition tolerance and network topology structure characteristics of the consensus mechanism are fully adapted.

This paper further deduces the partition tolerance in the hierarchical network topology structure, which applies not only to the general single-chain architecture, but also to the multi-chain and cross-chain architecture, from the computational method in the single network topology, and has broad application prospects.

This paper analyzes the resource overhead and partition tolerance in different network topologies and constructs single or hierarchical network topology structure with appropriate scale and high partition tolerance for the consortium blockchain consensus of different needs. Different levels of domains may use the same or different network topologies and parameters. The network topologies of different domains at the same level may also be different.

Generally, the evaluation of communication networks is based on the following basic assumptions:

1. All elements involved in the analysis have only two states: work and failure.

2. Failures and repairs between each analysis elements are independent of each other.

3. The MTBF (Mean Time Between Failures) and MTTR (Mean Time To Repair) of each analysis element are independent processes with no memory and constant mean value.

4. MTBF is much larger than MTTR.

Based on the above assumptions, since each element is in multiple processes of work-failure-repair, the Markov process can be used for mathematical description. The parameters are defined as follows:

v: Total number of network nodes.

l: Total number of network channels.

k: The minimum required some consensus nodes in the consortium blockchain consensus mechanism that satisfy consistency and availability, that is, if and only if the number of consensus nodes in a partition is more than k, this consortium blockchain consensus mechanism satisfies consistency and availability.

λ: The probability of failure of the channel per unit time, that is, λ=1/MTBF.

μ: The probability that a channel in the failure state is repaired in the unit time of the system, that is, μ=1/MTTR.

### (1). The Partition Tolerance Probability and Average Minimum Repair Time of a Single Network Topology Structure

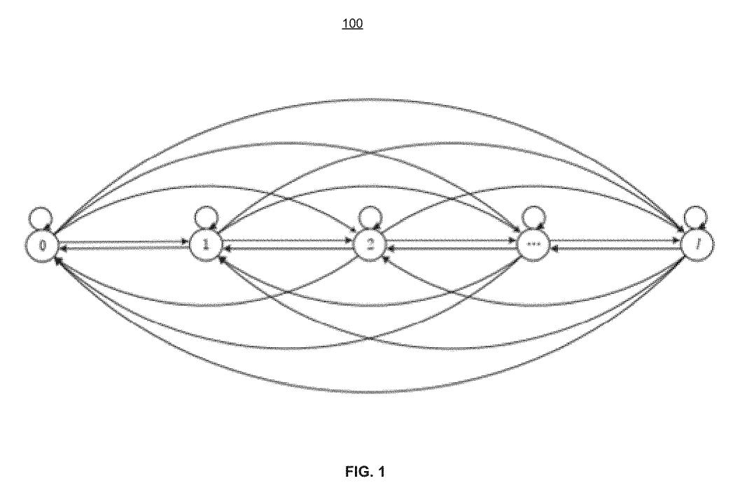

For a network topology structure containing v nodes and l channel (such as multi-dimensional hypercube structure or multi-point fully connected structure), make a Markov state transition diagram, as shown in FIG. 1. The i-th system state indicates that there are only i channels in the network in a failure state (0≤i≤1).

The state transition matrix of the Markov model is a matrix P of size (l+1)×(l+1), where the element pⱼᵢ represents the probability of transitioning from the i-th system state to the j-th system state. Let m denote the number of the same failure channels in state i and state j, then the value range of m is [max{i+j−l,0}, min{i,j}].

$${p}_{ji} = {\sum }_{m} P ( i - m failure channels fixed ) \cdot P ( j - m working channels failing ) = {\sum }_{m = ma x ( i + j - l , 0 \}}^{m i n \{ i , j \}} ( \begin{matrix}i \\ m\end{matrix} ) {{μ}^{i - m} ( 1 - μ )}^{m} \cdot ( \begin{matrix}l - i \\ j - m\end{matrix} ) {{λ}^{j - m} ( 1 - λ )}^{l - i - j + m} . \qquad ( 1 )$$

The state transition matrix P of the above Markov model satisfies three characteristics:

1. Since all elements of P are greater than or equal to 0, and the sum of the elements of a column represents the sum of the probabilities of all possible next jumps given an initial state, that is, the column sum of P is 1, then P satisfies randomness.

2. Since the failures and repairs between the channels are independent of each other, each system state may come from any other state, that is, the Markov state transition diagram is fully connected, so P satisfies the irreducibility.

3. As shown in FIG. 1, there is no simple loop between system states, so P satisfies non-periodicity.

Therefore, the above Markov process will eventually converge to a steady-state distribution independent of the initial distribution. Algorithm 1 describes the iterative calculation process for the steady-state probability of the system. The state transition matrix P is multiplied iteratively by itself. If the 2-norm of the difference between successive products is less than the given convergence precision, then the power of P at this time is considered to be the steady-state probability matrix P*.

Algorithm 1: Calculate the Steady State Probability

Input:
1. Eps: convergence precision;
2. P: state transition matrix;
Output: steady-state probability matrix P*
3. Initial Eps = 1 and P* = P;
4. While (Eps ≥ eps) // If the 2-norm of the difference between
the two matrices generated by the iteration is smaller than the convergence
precision, the matrix is considered to converge.
5. mid = P*;
6. P* = P*·P;
7. Eps = norm (P* − mid);
8. end

Since the MTBF and MTTR of each analysis element are independent processes with no memory and the constant mean value, it is possible to estimate the probability of failing to satisfy consistency or availability in the event of a partition failure with a given number of failure channels. Algorithm 2 describes the partition tolerance probability calculation process for a system in the single network topology structure. For the various states that the system in steady-state may be, it is sampled N times and estimated the probability of the partition failure occurred without satisfying consistency or availability. And then, the partition tolerance probability of the system is calculated according to the full probability formula.

Algorithm 2: Calculate the Partition Tolerance Probability

Input:
1. G = (V, L): topological graph;
2. N: sampling number;
3. K: minimum number of consensus nodes in a good partition;
4. P*: steady state probability matrix;
Output: partition tolerance probability p
5. initial p = 1;
6. for bad_num = 1: length (L)
7. count = 0;
8. for i=1:N // Estimate the probability of a partition
failure without satisfying consistency or availability
9. remove any bad_num edges from graph G to get graph subG;
10. [bins, binsizes] = the connected component parameters of
graph subG;
11. if max(bins) > 1&& max (binsizes)<k
12. Count++;
13. end
14. end
15. p−=P*(bad_num +1, 1)·(count / N);
16. end

The minimum repair time is defined as the minimum time required for the system to repair part of the channel in the event of a failure so that the system meets consistency and availability. Algorithm 3 describes the average minimum repair time calculation process for a system in the single network topology structure. Based on Algorithm 2, for each partition failure instance that does not meet the consistency or availability, calculate its minimum repair time, multiply by the weight of the instance in the whole system partition tolerance problem, and obtain the average minimum repair time of the system.

Algorithm 3: Calculate the Average Minimum Repair Time

Input:
1. G = (V, L): topological graph;
2. N1, N2: sampling number;
3. k: minimum number of consensus nodes in a good partition;
4. μ: the probability that a single broken edge is repaired per unit time;
5. P*: steady-state probability matrix;
6. p: partition tolerance probability;
Output: average minimum repair time time
7. initial time = 0;
8. for bad_num = 1: length (L)
9. min_repair_time=0; count = 0;
10. for i=1:N1 // Estimate the probability of a partition failure without satisfying
consistency or availability
11. remove any bad_num edges from graph G to get graph subG;
12. [bins, binsizes] = the connected component parameters of graph subG;
13. if max(bins) > 1&& max (binsizes)<k
14. repair_time = 0;
15. for repair_num = 1:bad_num
16. for j = 1: N2
17. repair any repair_num edges from the bad_num broken edges to get graph
subG;
18. [bins, binsizes] = the connected component parameters of graph subG;
19. if max(bins) > 1&& max (binsizes)<k
20. repair_time = repair_num;
21. break;
22. end
23. end
24. if repair_time > 0
25. break;
26. end
27. end
28. min_repair_time+ = repair_time;
29. count++;
30. end
31. end
32. time+ = min_repair_time / μ*P*(bad_num +1, 1) / N1 / (1−p);
33. end

### (2). The Partition Tolerance Probability and the Minimum Average Repair Time of the Hierarchical Network Topology Structure

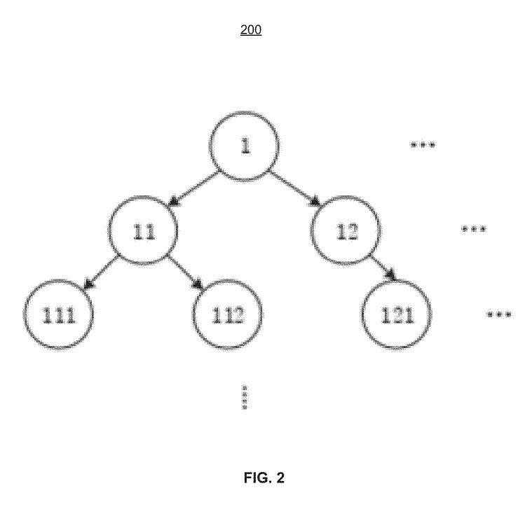

In a hierarchical network topology structure, after the lower-level domain node generates a block within the domain, the block is passed to the upper-level domain to continue the higher-level consensus. For an n-level network topology structure, each domain is numbered according to the tree structure of (i₁i₂i₃ . . . ), as shown in FIG. 2.

The partition tolerance of the lower-level domain is not only affected by its network topology structure but also related to the partition tolerance of the higher-level domain. Let p_{i1i2i3 . . .} denote the partition tolerance probability of each domain. Then the partition tolerance probability of the system is

p=1−Σ_{m=1(i1,i2,i3, . . . ,im)}ⁿΣpᵢ₁pᵢ₁ᵢ₂pᵢ₁ᵢ₂ᵢ₃ . . . p_{i1i2i3 . . . im-1}(1−p_{i1i2i3 . . . im}). (2)

For the same reason, let t_{i1i2i3 . . .} denote the average minimum repair time of each domain. Then the average minimum repair time of the system is

$$t = {\sum }_{m = 1 ( {i}_{1} , {i}_{2} , {i}_{3} , … , {i}_{m} )}^{n} \sum {t}_{i 1 i 2 i 3 … i m} \cdot \frac{{p}_{i 1} {p}_{i 1 i 2} {p}_{i 1 i 2 i 3} … {p}_{i 1 i 2 i 3 … i m - 1} ( 1 - {p}_{i 1 i 2 i 3 … i m} )}{1 - p} . \qquad ( 3 )$$

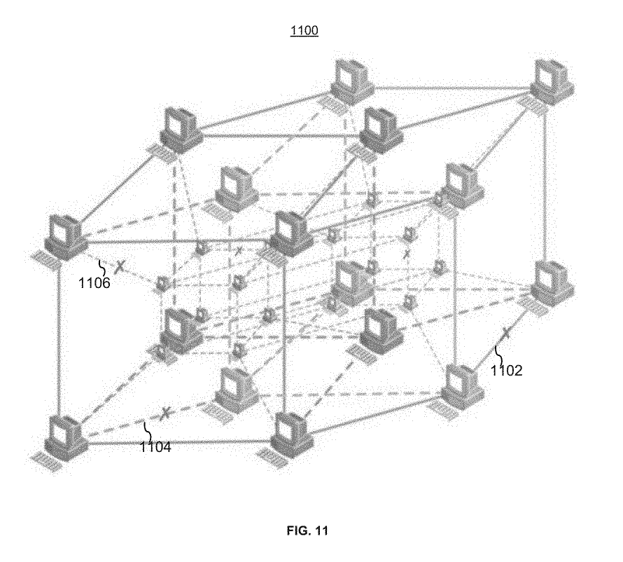

Taking the digital optical cable system as an example, the following is the calculation of the partition tolerance probability and the average minimum repair time when the Proof of Vote (PoV) in the consortium blockchain adopts the 2- to 5-dimensional hypercube network topology and the 4- to 10-point fully connected network topology. An example of the 5-d hypercube is shown in FIG. 11, which a schematic diagram of an example 5-d hypercube topology with nodes that are not directly connected in accordance with some implementations of the present disclosure. In FIG. 11, a cross on an edge represents that the corresponding link in the network is not connected. For example, edges 1102, 1104, and 1106 are missing and the nodes are not connected by those missing edges.

According to national standards, the digital optical cable communication system with automatic switching function of the primary and backup systems should meet the full year indicators shown in Table 1. Therefore, take the parameter pair (λ,μ)∈{(4.5662×10⁻⁴, 4.1667 ×10⁻²), (2.7397×10⁻⁴, 6.9444×10⁻²), (3.8358×10⁻⁵, 4.9603×10⁻¹), (2.5571×10⁻⁵, 7.4405×10⁻¹)}.

TABLE 1
Digital optical cable communication system reliability indicators

| | | | | |
|---|---|---|---|---|
| Link length/ | 5000 | 3000 | 420 | 280 |
| km | | | | |
| The number of | 4 | 2.4 | 0.336 | 0.224 |
| two-way failures | | | | |
| MTBF/h | 2190 | 3650 | 26070 | 39107 |
| φ/fit | 456620 | 273970 | 38358 | 25570 |
| MTTR/h | 24 | 14.4 | 2.016 | 1.344 |
| F/% | 0.274 | 0.164 | 0.023 | 0.015 |
| A/% | 99.726 | 99.836 | 99.977 | 99.985 |

The resource overhead of the multi-dimensional hypercube and multi-point fully connected network topologies are shown in Table 2.

TABLE 2
The resource overhead of the multi-dimensional hypercube
and multi-point fully connected network topologies

| Topology | Hypercube | | | | Full connection | | | |
|---|---|---|---|---|---|---|---|---|
| structure | 2-d | 3-d | 4-d | 5-d | 4-point | 6-point | 8-point | 10-point |
| Number of | 4 | 8 | 16 | 32 | 4 | 6 | 8 | 10 |
| nodes v | | | | | | | | |
| Number of | 4 | 12 | 32 | 80 | 6 | 15 | 28 | 45 |
| channels l | | | | | | | | |

In the PoV consensus,

$$k = \frac{v}{2 } + 1.$$

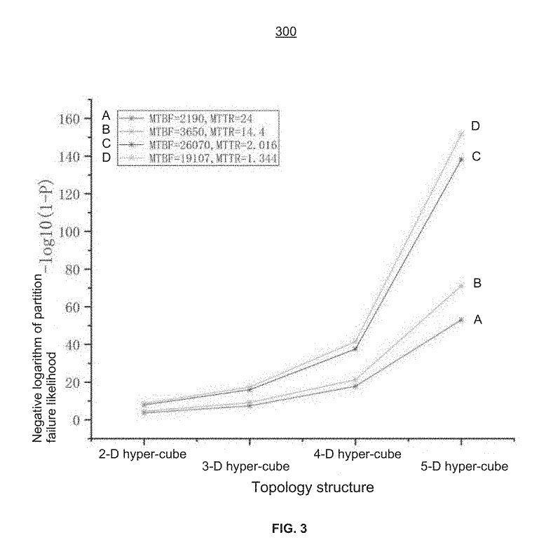

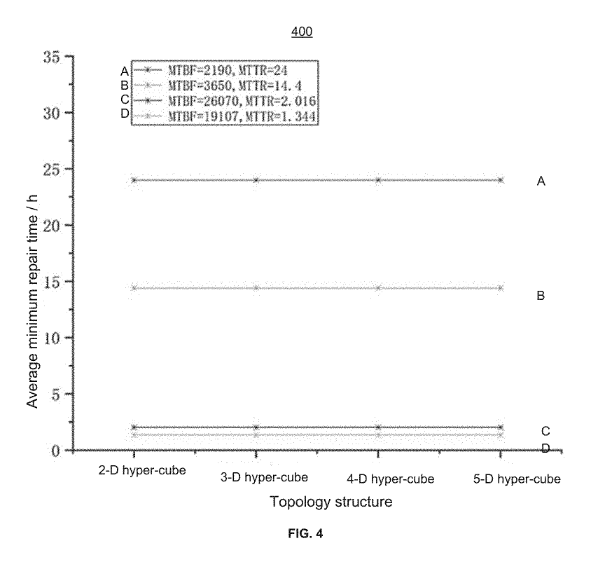

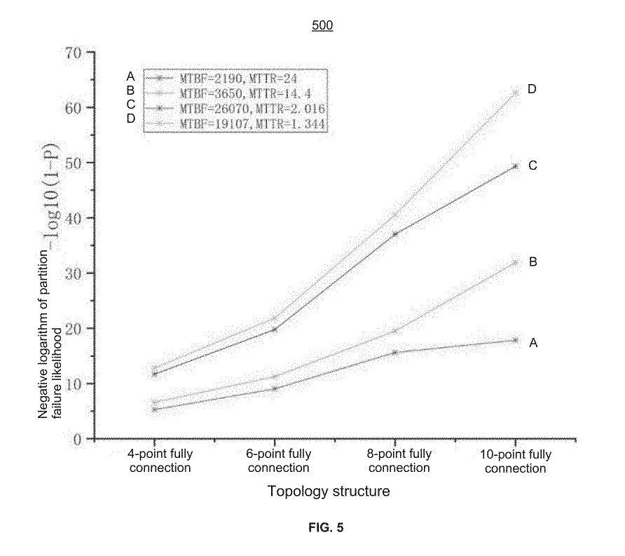

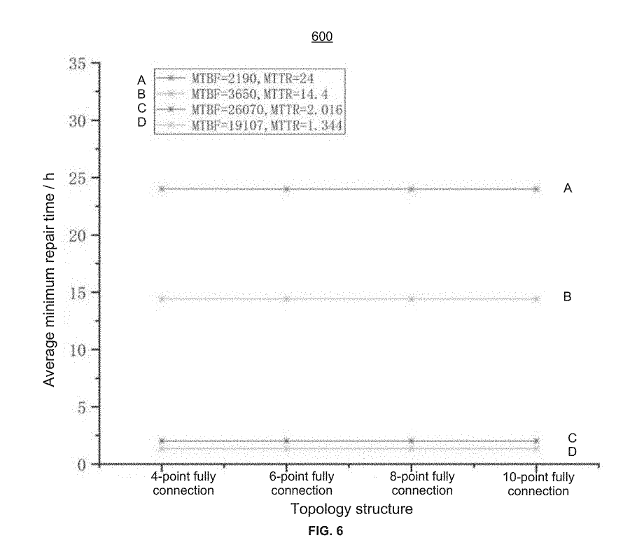

The calculation results of the partition tolerance probability and the average minimum repair time are shown in FIGS. 3-6.

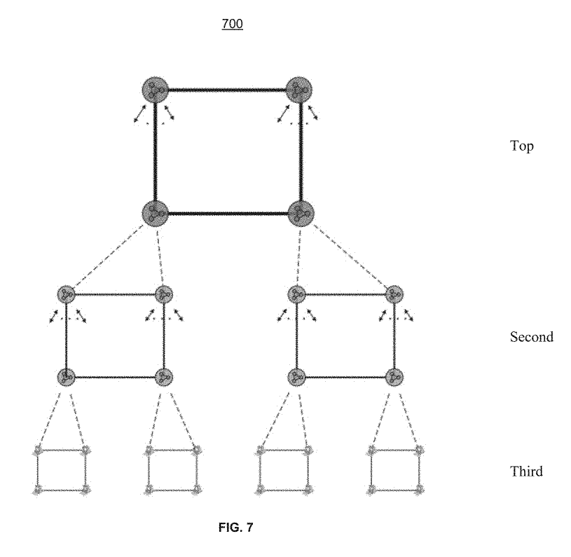

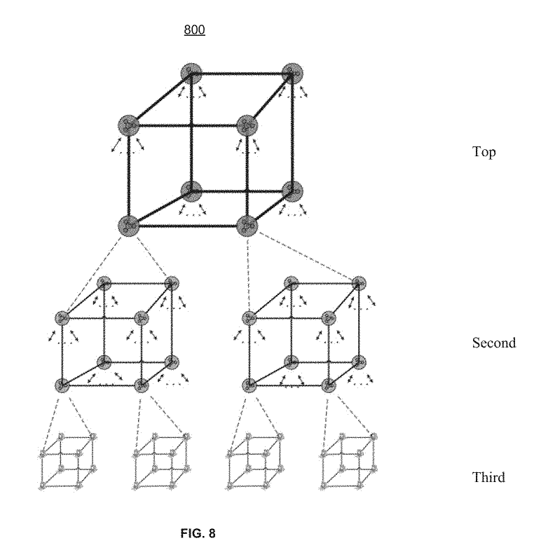

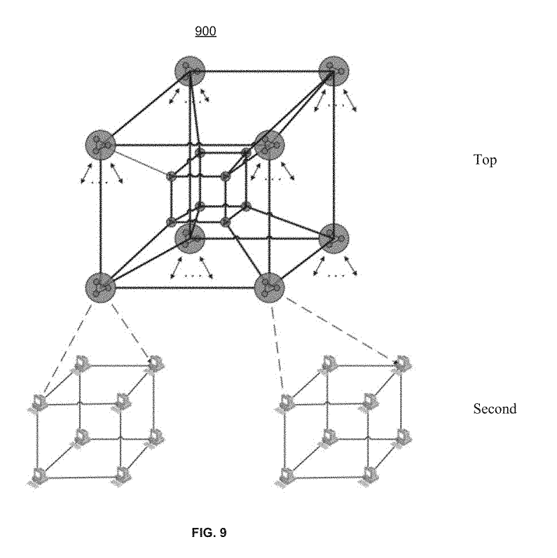

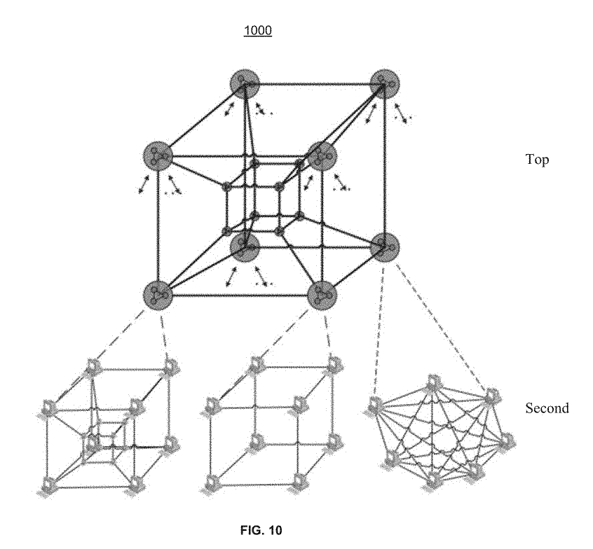

Continue to consider the four hierarchical network topologies as shown in FIGS. 7-10. FIG. 7 shows the lower boundary of the method in accordance with some implementations of the present disclosure, that is, the topology of the top, second and third domains are all two-dimensional hypercubes; FIG. 8 shows a completely symmetrical three-level topology construction method. The topology of the top, second and third domains are all 3-dimensional hypercubes. FIG. 9 shows a semi-symmetric two-level topology construction method. The topologies between the same-level domain are the same, but the top domain topology is 4-dimensional hypercubes, and the second domain topologies are all 3-dimensional hypercubes. FIG. 10 shows an asymmetric two-level topology construction method. The topology structures between the upper and lower domains and the same domain are all different. Specifically, the structure includes a top domain adopting a 4-dimensional hypercube structure, and at the same time includes 4, 8, and 4 second domains adopting 4-dimensional hypercubes, 3-dimensional hypercubes, and 7-point fully connected structures respectively.

Assume that the link lengths of the top, second, and third domains in FIGS. 7-10 are 5000 km, 3000 km, and 420 km, respectively. Using the calculation results of partition tolerance for multi-dimensional hypercube and multi-point fully connected in FIGS. 3-6, the partition tolerance and average minimum repair time of the four hierarchical network topologies in FIGS. 7-10 are further calculated as:

(1) Lower boundary situation

p=1−[(1−p₁)+p₁*(1−p₁₁)*4+p₁*p₁₁*(1−p₁₁₁)*4*4]≈1−4×10⁻⁴/h, that is, a partition failure will occur approximately every 3 months.

t=[t₁*(1−p₁)+t₁₁*p₁*(1−p₁₁)*4+t₁₁₁*p₁*p₁₁*(1−p₁₁₁)*4*4]/(1−p)≈21 h, that is, the average minimum repair time after a partition failure is approximately 21 hours.

(2) Completely symmetric 3-level topology

p=1−[(1−p₁)+p₁*(1−p₁₁)*8+p₁*p₁₁*(1−p₁₁₁)*8*8]≈1−5×10⁻⁸/h, that is, a partition failure will occur approximately every 2,283 years.

t=[t₁*(1−p₁)+t₁₁*p₁*(1−p₁₁)*8+t₁₁₁*p₁*p₁₁*(1−p₁₁₁)*8*8]/(1−p)≈23 h, that is, the average minimum repair time after a partition failure is approximately 23 hours.

(3) Semi-symmetric 2-level topology

p=1−[(1−p₁)+p₁*(1−p₁₁)*16]≈1−1×10⁻⁸, that is, a partition failure will occur every 11,416 years.

t=[t₁*(1−p₁)+t₁₁*p₁*(1−p₁₁)*16]/(1−p)≈14 h, that is, the average minimum repair time after a partition failure is approximately 14 hours.

(4) Asymmetrical 2-level topology

p=1−[(1−p₁)+p₁*(1−p₁₁)*4+p₁*(1−p₁₂)*8+p₁*(1−p₁₃)*4]≈1−6×10⁻⁹, that is, a partition failure will occur approximately every 19,026 years.

t=[t₁*(1−p₁)+t₁₁*p₁*(1−p₁₁)*4+t₁₂*p₁*(1−p₁₂)*8+t₁₃*p₁*(1−p₁₃) *4]/(1−p)≈14 h, that is, the average minimum repair time after a partition failure is approximately 14 hours.

Another object of the present disclosure is to provide a topology construction system that satisfies the partition tolerance in the consortium blockchain consensus, and the topology construction system includes:

a combination module configured to combine the consortium blockchain consensus mechanism with the network topology to make the consortium blockchain consensus satisfy the partition tolerance in terms of probability;

a convergence module configured to abstract the partition tolerance of the system into a class of convergent Markov process and to obtain the steady-state probability of the system;

a sampling estimation module configured to estimate the probability and the minimum repair time of failing to meet consistency or availability in the event of a partition failure with a given number of failure channels, and to obtain the partition tolerance probability and the average minimum repair time of the system; and

a network construction module configured to analyze the resource overhead and the partition tolerance under different network topologies according to the obtained partition tolerance probability and the average minimum repair time and to construct the network topology with suitable size and higher partition tolerance for the consortium blockchain consensus of different needs.

In some implementations, the Markov process in the convergence module converges to a steady-state distribution independent of the initial distribution, and in the single network topology, computing the steady-state probability of the system includes:

a loop multiplication unit configured to multiply a state transition matrix P iteratively by itself; and

a determining unit configured to determine whether a 2-norm of the difference between two consecutive products is smaller than a set convergence precision; wherein if it is less than, the power value of P at this time is determined to be the steady-state probability matrix P*, and if it is not less than, returning to the loop multiplication unit.

In some implementations, the MTBF and MTTR of each analysis element in the sampling estimation module are independent processes with no memory and constant mean value; and in the single network topology structure, computing the partition tolerance probability of the system includes:

a sampling unit configured to sample N times for each possible state of the steady-state system;

an estimation unit configured to estimate a probability and an average minimum repair time of failing to meet consistency or availability in the event of a partition failure; and

a calculation unit configured to calculate the partition tolerance probability of the system according to a full probability formula, wherein the full probability formula is: p=1−Σᵢ₌₁^{l}P{steady-state i}P{failing to meet consistency or availability in the event of a partition failure|steady-state i}, 1 indicates the total number of channels, and i indicates that only i channels are in a failure state in the steady-state system.

In some implementations, in the single network topology structure, computing the average minimum repair time of the system includes:

a calculating the minimum repair time unit configured to calculate the minimum repair time for each sample that fails to meet consistency or availability in the event of a partition failure; and

a calculating the average minimum repair time unit configured to multiply with a weight of the sample in the whole system partition tolerance problem, and to obtain the average minimum repair time of the system.

In some implementations, in the hierarchical network topology structure, according to the process of consensus, the partition tolerance of a lower-level domain is not only affected by its network topology structure but is also related to the partition tolerance of a higher-level domain; wherein the partition tolerance probability of the system is p=1−Σₘ₌₁ⁿΣ(i₁,i₂,i₃, . . . ,iₘ) pᵢ₁pᵢ₁ᵢ₂pᵢ₁ᵢ₂ᵢ₃ . . . P_{i1i2i3 . . . im-1}(1−p_{i1i2i3 . . . im}); wherein the average minimum repair time of the system is

$$t = {\sum }_{m = 1}^{n} \sum ( {i}_{1} , {i}_{2} , {i}_{3} , … , {i}_{m} ) {t}_{i 1 i 2 i 3 … i m} \cdot \frac{pi 1 pi 1 i 2 pi 1 i 2 i 3 … pi 1 i 2 i 3 … i m - 1 ( 1 - Pi 1 i 2 i 3 … i m )}{1 - p} ;$$

where p_{i1i2i3 . . .} represents the partition tolerance probability of each domain, and t_{i1i2i3 . . .} represents the average minimum repair time of each domain.

FIG. 12 is a flowchart of a topology construction method 1200 for satisfying partition tolerance in the consortium blockchain consensus in accordance with some implementations of the present disclosure.

The method 1200, in some implementations, includes: combining (1202) a consortium blockchain consensus mechanism with a network topology to make the consortium blockchain consensus meet the partition tolerance in probability; abstracting (1204) the partition tolerance of the system into a class of convergent Markov process and obtain the steady-state probability of the system; estimate (1206) a probability and a minimum repair time of failing to meet consistency or available in the event of a partition failure with a given number of failure channel, and a partition tolerance probability and an average minimum repair time of the system are obtained; and analyzing (1208) a resource overhead and a partition tolerance under different network topologies according to the obtained partition tolerance probability and the average minimum repair time, and construct a network topology structure with suitable scale and high partition tolerance for the consortium blockchain consensus of different needs

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details. In general, well-known instruction instances, protocols, structures, and techniques have not been shown in detail.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What is claimed is:

1. A topology construction method for satisfying partition tolerance in the consortium blockchain consensus, comprising:
S1. Combining the consortium blockchain consensus mechanism with the network topology structure to make the consortium blockchain consensus satisfy the partition tolerance in probability;
S2. Abstracting a partition tolerance of a system into a class of convergent Markov process and computing a steady-state probability of the system, wherein the Markov process converges to a steady-state distribution independent of the initial distribution, and in the single network topology structure, computing a steady-state probability of the system comprises the following steps:
S21. Multiplying the state transition matrix P iteratively by itself; and
S22. Determining whether a 2-norm of the difference between two consecutive products is less than a set convergence precision; wherein if less than, determining that the power value of P at this time is a steady-state probability matrix P□ and if not less than, returning to the step S21;
S3. Estimating a probability and an average minimum repair time of failing to meet consistency or availability in the event of a partition failure with a given number of failure channels, and a partition tolerance probability and an average minimum repair time of the system are obtained;
S4. Analyzing a resource overhead and a partition tolerance under different network topologies according to the obtained partition tolerance probability and the average minimum repair time, and constructing the network topology structure with suitable scale and high partition tolerance for the consortium blockchain consensus of different needs.
The topology construction method for satisfying the partition tolerance in the consortium blockchain consensus as claimed in claim 1,

2. The topology construction method for satisfying the partition tolerance in the consortium blockchain consensus as claimed in claim 1, wherein the MTBF and MTTR of each analysis element in the step S3 are independent processes with no memory and constant mean value; and in the single network topology structure, computing the partition tolerance probability of the system comprises the following steps:
S311. Sampling N times for each possible state of the steady-state system;
S312. Estimating a probability of failing to satisfy consistency or availability in the event of a partition failure in each state; and
S313. Calculating the partition tolerance probability of the system according to a full probability formula, wherein the full probability formula is: p=1−Σᵢ₌₁^{l}P{steady-state i}P{failing to meet consistency or availability in the event of a partition failure|steady-state i}, 1 indicates the total number of channels, and i indicates that only i channels are in a failure state in the steady-state system.

3. The topology construction method for satisfying partition tolerance in the consortium blockchain consensus as claimed in claim 2, wherein in the single network topology structure, computing the average minimum repair time of the system comprises the following steps:
S321. Calculating a minimum repair time for each sample that has failed to meet consistency or availability in the event of a partition failure; and
S322. Multiplying the weight of the sample in the whole system partition tolerance problem, and computing the average minimum repair time of the system.

4. The topology construction method for satisfying partition tolerance in the consortium blockchain consensus according to any one of claims 1 to 4, wherein in the hierarchical network topology, according to the process of consensus, the partition tolerance of a lower-level domain is not only affected by its network topology, but is also related to the partition tolerance of a higher-level domain; wherein the partition tolerance probability of the system is p=1−Σₘ₌₁ⁿΣ(i₁,i₂,i₃, . . . ,iₘ) pᵢ₁pᵢ₁ᵢ₂pᵢ₁ᵢ₂ᵢ₃ . . . p_{i1i2i3 . . . im-1}(1−p_{i1i2i3 . . . im}); wherein the average minimum repair time of the system is
$$t = {\sum }_{m = 1}^{n} \sum ( {i}_{1} , {i}_{2} , {i}_{3} , … , {i}_{m} ) {t}_{i 1 i 2 i 3 … i m} \cdot \frac{pi 1 pi 1 i 2 pi 1 i 2 i 3 … pi 1 i 2 i 3 … i m - 1 ( 1 - Pi 1 i 2 i 3 … i m )}{1 - p} ;$$
where p_{i1i2i3 . . .} represents the partition tolerance probability of each domain, and t_{i1i2i3 . . .} represents the average minimum repair time of each domain.

5. A topology construction system for satisfying the partition tolerance in the consortium blockchain consensus, wherein the topology construction system comprises:
a combination module configured to combine the consortium blockchain consensus mechanism and the network topology structure to make the consortium blockchain consensus probabilistically satisfy partition tolerance;
a convergence module configured to abstract the partition tolerance of the system into a class of convergent Markov process and to obtain a steady-state probability of the system, wherein the Markov process in the convergence module converges to a steady-state distribution independent of the initial distribution, and wherein in the single network topology, computing the steady-state probability of the system comprises:
a loop multiplication unit configured to multiply a state transition matrix P iteratively by itself; and
a determining unit configured to determine whether a 2-norm of the difference between two consecutive products is smaller than a set convergence precision; wherein if it is less than, the power value of P at this time is determined to be a steady-state probability matrix P□, and if it is not less than, returning to the loop multiplication unit;
a sampling estimation module configured to estimate a probability and a minimum repair time of failing to meet consistency or availability in the event of a partition failure with a given number of failure channels, and to obtain a partition tolerance probability and an average minimum repair time of the system; and
a network construction module configured to analyze a resource overhead and the partition tolerance under different network topologies according to the obtained partition tolerance probability and the average minimum repair time and to construct the network topology with suitable size and higher partition tolerance for the consortium blockchain consensus of different needs.

6. The topology construction system for satisfying partition tolerance in the consortium blockchain consensus according to claim 5, wherein the MTBF and MTTR of each analysis element in the sampling estimation module are independent processes with no memory and constant mean value; wherein in the single network topology structure, computing the partition tolerance probability of the system comprises:
a sampling unit configured to sample N times for each possible state of the steady-state system;
an estimation unit configured to estimate a probability and an average minimum repair time of failing to meet consistency or availability in the event of a partition failure; and
a calculation unit configured to calculate the partition tolerance probability of the system according to a full probability formula, wherein the full probability formula is: p=1−Σᵢ₌₁^{l}P{steady-state i}P{failing to meet consistency or availability in the event of a partition failure|steady state i}, 1 indicates the total number of channels, and i indicates that only i channels are in a failure state in the steady-state system.

7. The topology construction system for satisfying partition tolerance in the consortium blockchain consensus according to claim 6, wherein in the single network topology, the average minimum repair time of computing the system comprises:
a calculating the minimum repair time unit configured to calculate the minimum repair time for each sample that fails to meet consistency or availability in the event of a partition failure; and
a calculating the average minimum repair time unit configured to multiply with a weight of the sample in the whole system partition tolerance problem, and to obtain the average minimum repair time of the system.

8. The topology construction system for satisfying partition tolerance in the consortium blockchain consensus according to claim 7, wherein in the hierarchical network topology structure, according to the process of consensus, the partition tolerance of a lower-level domain is not only affected by its network topology structure, but is also related to the partition tolerance of a higher-level domain; wherein the partition tolerance probability of the system is p=1−Σₘ₌₁ⁿΣ(i₁,i₂,i₃, . . . ,iₘ)pᵢ₁pᵢ₁ᵢ₂pᵢ₁ᵢ₂ᵢ₃ . . . p_{i1i2i3 . . . im-1}(1−p_{i1i2i3 . . . im}); wherein the average minimum repair time of the system is
$$t = {\sum }_{m = 1}^{n} \sum ( {i}_{1} , {i}_{2} , {i}_{3} , … , {i}_{m} ) {t}_{i 1 i 2 i 3 … i m} \cdot \frac{pi 1 pi 1 i 2 pi 1 i 2 i 3 … pi 1 i 2 i 3 … i m - 1 ( 1 - Pi 1 i 2 i 3 … i m )}{1 - p} ;$$
where p_{i1i2i3 . . .} represents the partition tolerance probability of each domain, and t_{i1i2i3 . . .} represents the average minimum repair time of each domain.
